(19) United States
(12) Patent Application Publication
(10) Pub. No.: US 2010/0133804 A1
(43) Pub. Date: Jun. 3, 2010

(54) Method of replacing pipe couplings

(76) Inventor: Brent Larkin, Las Vegas, NV (US)

Correspondence Address: RUSSO & DUCKWORTH, LLP, 9090 Irvine Center Drive, Irvine, CA, 92618, US

(21) Appl. No.: 12/315,324

(22) Filed: Dec. 1, 2008

(51) Int. Cl. F16L 55/00

(52) U.S. Cl. 285/16

(57) ABSTRACT

A method of replacing pipe couplings is provided. The couplings, such as elbow joints, “T” couplings, “Y” couplings, etc., have a traditional conduit construction including tubular end sections which telescopically connect to pipe ends. The couplings are removed by cutting the pipes adjacent to the couplings tubular sections so that the pipes have a reduced length. A replacement coupling is connected to the pipe ends. The replacement coupling has tubular sections which are extended to have an increased length “L”. The increased length allows the replacement coupling to mate to the respective pipes even though the pipes have a shortened length than prior to removal of the replaced coupling.

### BACKGROUND OF THE INVENTION

The present invention relates to methods and constructions for repairing pipe joints. More particularly, the present invention relates to a method of replacing preexisting couplings within a pipe joint.

For both brass and polyvinylchloride (PVC) piping, it is common to form a pipe joint by inserting the male pipe ends into the female openings in a joint coupling. Once the pipe ends are telescopically received within the coupling, the pipes are adhered to the coupling by use of various methods including the use of welding and adhesive compounds. As examples only, PVC pipe joints typically utilize liquid adhesives to adhere the PVC coupling to the respective pipe ends. Conversely, brass fittings are typically adhered in place using conventional welding methods. More recently, couplings affix to pipe ends using press-fit configurations in combination with O-rings and mechanical locking flanges.

Forming an initial pipe joint is relatively uncomplicated. However, as with all types of pipes, PVC and brass couplings will occasionally crack and need to be replaced. Unfortunately, repairing or replacing a pipe coupling can be difficult and time consuming.

With reference to FIGS. 15 and 17-19, the typical method for replacing a coupling, such as the elbow coupling illustrated in the figures, typically entails cutting the pipe on either side of the coupling so as to entirely remove the coupling and the ends of each pipe. Since the pipe ends are no longer sufficiently long so that a traditional coupling of the same size can be utilized, the pipes must be extended utilizing still additional couplings in the form of sleeves to add additional pipe length. (See FIGS. 17 and 18). Thereafter, the elbow coupling can be replaced by telescopically inserting the new pipe ends into the tubular openings of the elbow coupling. The elbow joint coupling and the pipe extension couplings are adhered in place utilizing an adhesive in the case of PVC piping or a weld with brass piping.

Accordingly, the typical replacement of a pipe coupling typically requires two additional couplings to provide pipe extensions. Moreover, the additional couplings provide four additional interfaces wherein leaks are prone to form. In addition, the replacement of the elbow joint coupling is extremely time consuming and mistakes are prone to happen in the extension of the pipe ends which must be measured relatively accurately for installation of the replacement elbow couplings.

Thus, there is a need for an improved method of replacing pipe couplings which provides for more rapid replacement of a coupling.

There is also a need for an improved method for replacing pipe couplings which does not require the installation of additional couplings which would be prone to leakage.

There is still an additional need for a method of replacing pipe couplings which is inexpensive and simple to implement.

### SUMMARY OF THE INVENTION

The present invention addresses the aforementioned disadvantages by providing an improved method for replacing pipe couplings. As illustrated in FIGS. 1 and 3, prior art couplings are conduits which typically include tubular input sections at their extremities. Pipe couplings may include two tubular input sections as is the case in elbow joints shown in FIGS. 1 and 3 and as with male to male, male to female, and female to male pipe couplings illustrated in FIGS. 9, 11 and 13. However, pipe couplings may also include three or more tubular input sections as with “Y” couplings illustrated in FIG. 5 or “T” couplings illustrated in FIG. 7.

The method of replacing a pipe coupling of the present invention includes providing a conventional pipe joint including a first coupling to be replaced. The coupling includes at least two tubular input sections with the first tubular input section telescopically joined to a first pipe end and the second tubular input section telescopically joined to a second pipe end. (See FIG. 15). The invention further includes providing a second coupling for use in replacing the damaged first coupling. The second coupling has a configuration substantially the same as the first coupling. For example, if the first coupling to be replaced is a 90 degree elbow joint, the second coupling is also preferably a 90 degree elbow joint. Though not typical, the person replacing the initial elbow joint coupling may desire to add an additional pipe connection. Thus, the second “replacement” coupling may be a pipe coupling including three or more input sections such as found in a “T” connector. Of importance, the replacement pipe coupling has tubular input sections which have a length substantially greater than the length of the initial first couplings input sections.

The method of replacing the initial pipe coupling includes the step of removing the first coupling from the pipe joint by cutting the pipes adjacent to the pipe coupling with the ends of the pipe telescopically still received within the coupling. The coupling can then easily be removed.

After the replaced coupling has been removed, thereby leaving two pipe ends in proximity to one another, the replacement coupling having tubular input sections of greater length is mated to the pipe ends. Specifically, each of the pipe ends are telescopically joined to the respective tubular input sections of the replacement coupling. Typically, the replacement coupling will have tubular sections which have an inner diameter substantially the same as the outer diameter of the pipes so that the pipe ends are inserted into the couplings tubular input sections to form a press-fit arrangement. Since the couplings input sections have greater length than the input sections of the replaced coupling, the pipe ends can be mated to the replacement coupling without introduction of pipe extensions and corresponding extension couplings. Then, the replacement coupling is affixed in place utilizing an adhesive for PVC piping or welding for brass piping. The replacement coupling may also be affixed to the pipe ends utilizing a press-fit arrangement, preferably with O-rings and locking flanges.

Advantageously, the method of replacing the pipe coupling of the present invention is simple and inexpensive to implement.

Another advantage of the present invention is that additional couplings, such as extension couplings, do not need to be utilized, thereby eliminating points of potential leakage.

Still another advantage of the present invention is that the method of replacing the pipe coupling of the present invention is less time consuming and difficult than the previous method requiring the introduction of pipe extensions and additional couplings.

These and other objects and advantages of the present invention will be apparent to those skilled in the art from the following detailed description taken in conjunction with the drawings.

### BRIEF DESCRIPTION OF THE FIGURES

FIG. 1 is a perspective view of a 90 degree elbow coupling of the prior art;

FIG. 2 is a perspective view of a 90 degree coupling including extended tubular input sections for use with the method of the present invention;

FIG. 3 is a perspective view of a 45 degree elbow joint of the prior art;

FIG. 4 is a perspective view of a 45 degree coupling including extended tubular input sections for use with the method of the present invention;

FIG. 5 is a perspective view of a prior art “Y” coupling;

FIG. 6 is a perspective view of a “Y” coupling including extended tubular input sections for use with the method of the present invention;

FIG. 7 is a “T” coupling of the prior art;

FIG. 8 is a “T” coupling including extended tubular input sections for use with the method of the present invention;

FIG. 9 is a perspective view of a male-to-male coupling of the prior art;

FIG. 10 is a perspective view of a male-to-male coupling including extended tubular input sections for use with the method of the present invention;

FIG. 11 is a perspective view of a male-to-female coupling of the prior art;

FIG. 12 is a perspective view of a male-to-female coupling wherein a tubular section has an extended length;

FIG. 13 is a perspective view of a female-to-male coupling of the prior art;

FIG. 14 is a perspective view of a female-to-male coupling having an extended tubular section for use with the method of present invention;

FIG. 15 is a perspective view illustrating a conventional pipe joint with an elbow coupling having a crack;

FIG. 16 is a perspective view illustrating a person cutting the pipe ends to remove the cracked pipe coupling shown in FIG. 15;

FIG. 17 is an exploded perspective view illustrating the connection of the various pipe elements in connection with the prior art method of replacing a pipe coupling;

FIG. 18 is a perspective view illustrating a pipe coupling replaced in accordance with the method of the prior art;

FIG. 19 is a perspective view illustrating the removal of an elbow pipe coupling from a pipe joint in accordance with the present invention;

FIG. 20 illustrates a pipe joint with a replacement elbow pipe coupling have tubular sections of extended length utilized in replacing the pipe coupling shown in FIG. 19 in accordance with the method of the present invention;

FIG. 21 is a perspective view illustrating the removal of a “T” pipe coupling from a pipe joint in accordance with the present invention; and

FIG. 22 illustrates a pipe joint with a replacement “T” pipe coupling have tubular sections of extended length utilized in replacing the pipe coupling shown in FIG. 21 in accordance with the method of the present invention;

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and the present disclosure is not intended to limit the invention to specific embodiments illustrated.

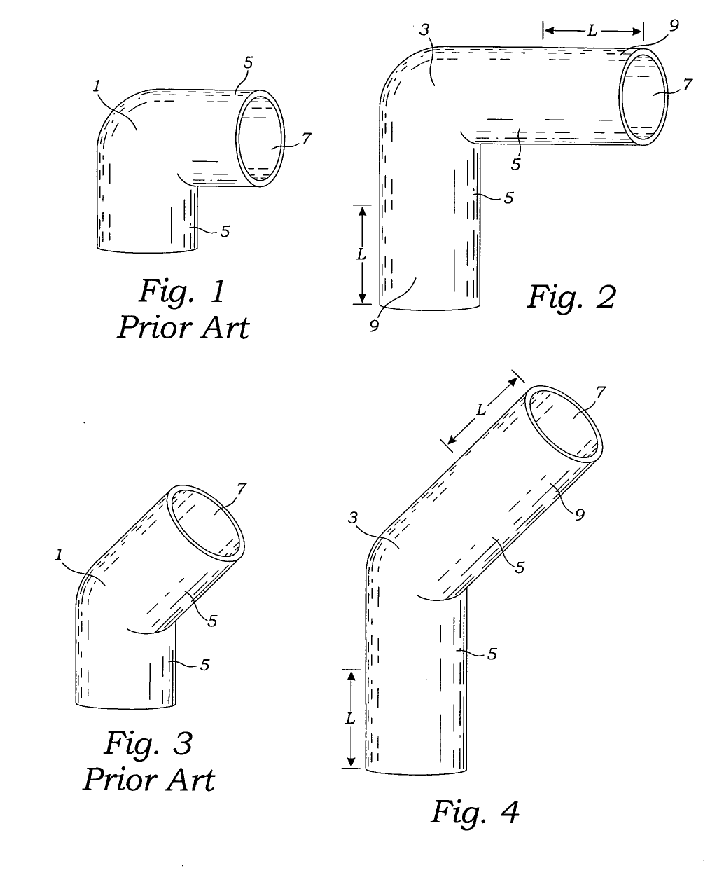

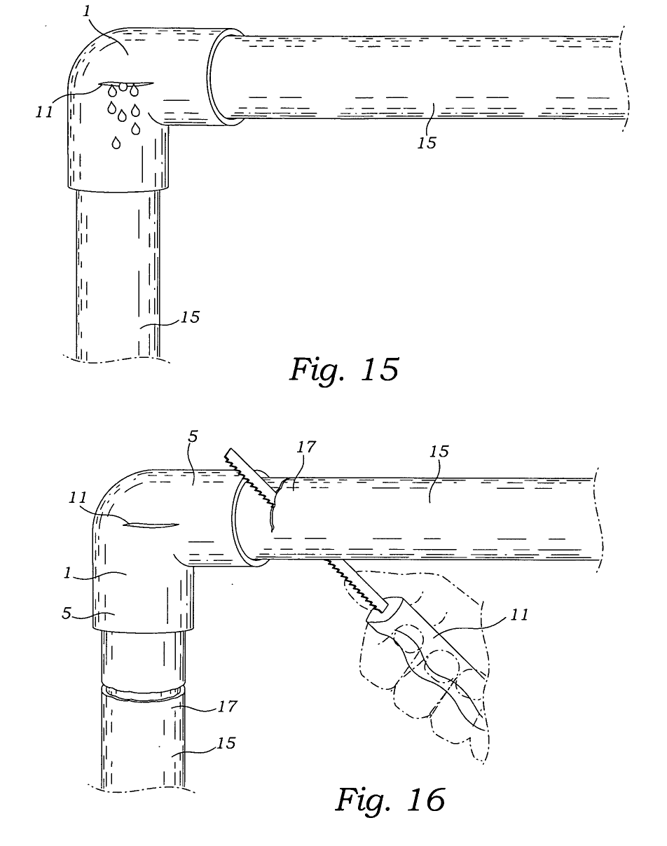

With reference to FIGS. 1-22, the present invention is directed to a method of replacing a coupling 1 which may need to be replaced for a variety of reasons such as a crack or leak as illustrated in FIGS. 15, 19 and 21. The method of replacing the coupling 1 entails cutting the pipe 15 adjacent to the coupling's extremities using a handsaw, electric saw, rotating pipe cutting tool or the like as can be selected by those skilled in the art. Once the pipe ends have been cut, the coupling 1 can be manually removed. Unfortunately, this leaves the pipes' length less than prior to removal of the coupling 1.

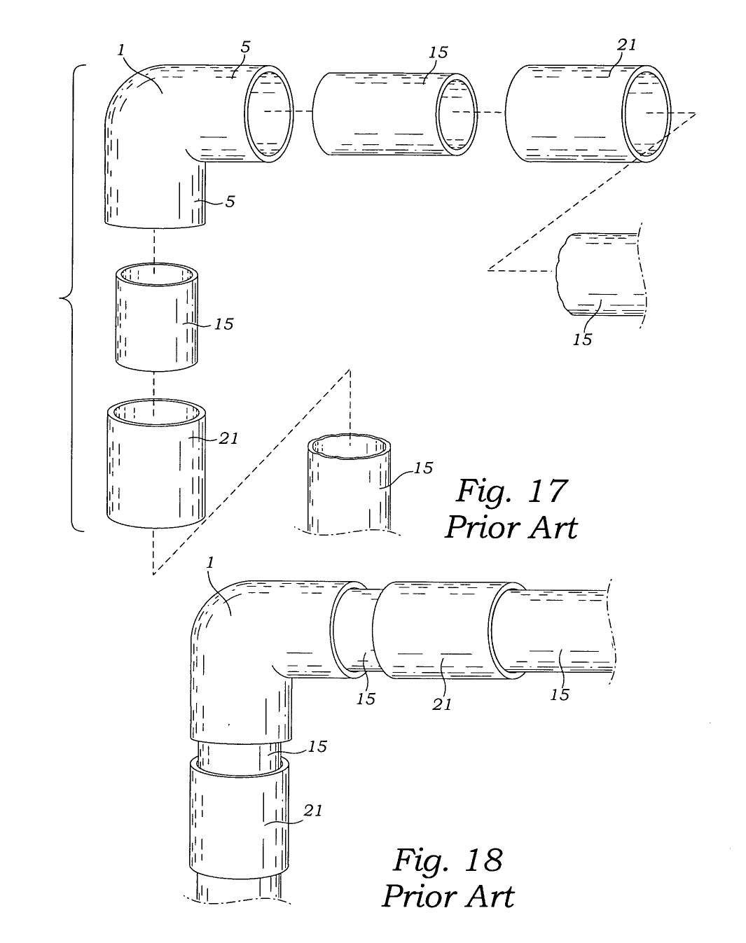

In accordance with the invention, instead of extending the pipe length using extension couplings 21 as illustrated in FIGS. 17 and 18, a replacement coupling is employed which has tubular sections 5 having an increased length “L”, as illustrated in FIGS. 2, 4, 6, 8, 10, 12, 14, 20 and 22. The replacement coupling 3 is installed in similar manner to the manner that the initial replaced coupling was installed. More specifically, pipe ends 17 are telescopically joined to the tubular input sections 5 of the replacement coupling 3. Specifically, the pipe ends 17 are manually forced into a press-fit mating arrangement in which the pipe ends are slid into the larger bore 7 of the replacement coupling 3. Alternatively, though less common, the replaced coupling may have an outer diameter smaller than the inner diameter of the pipe 15. In such cases, the tubular sections 5 of the replacement coupling 3 will be slid into the central bore of the pipe ends 17. The coupling and pipe ends are then affixed to each other utilizing known adhesives, known welding methods, or a simple press-fit arrangement, preferably with a locking flange.

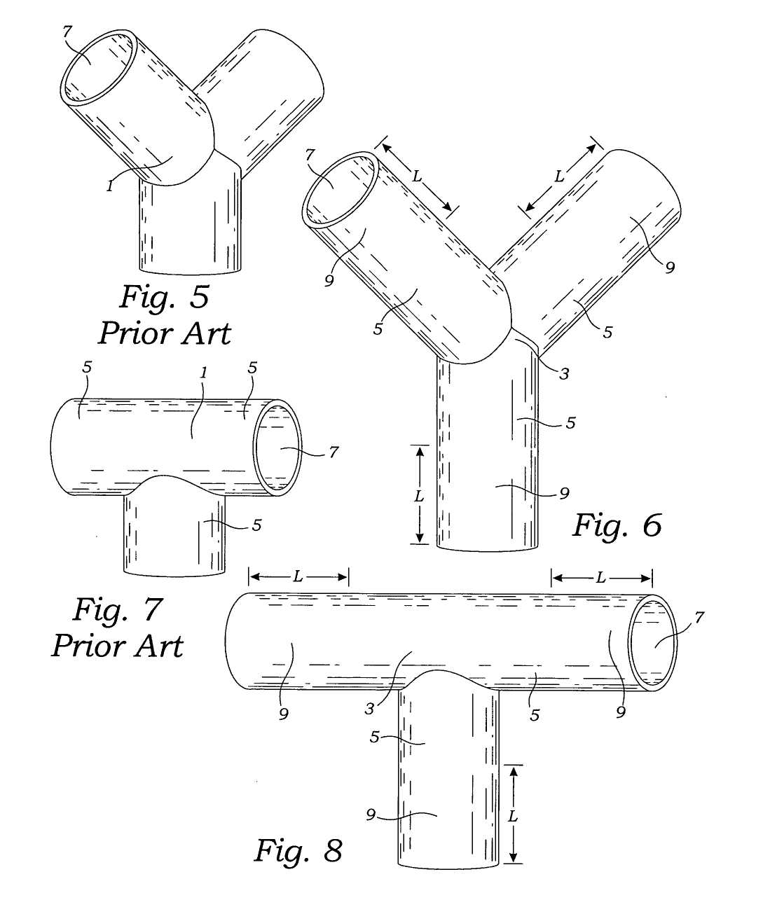

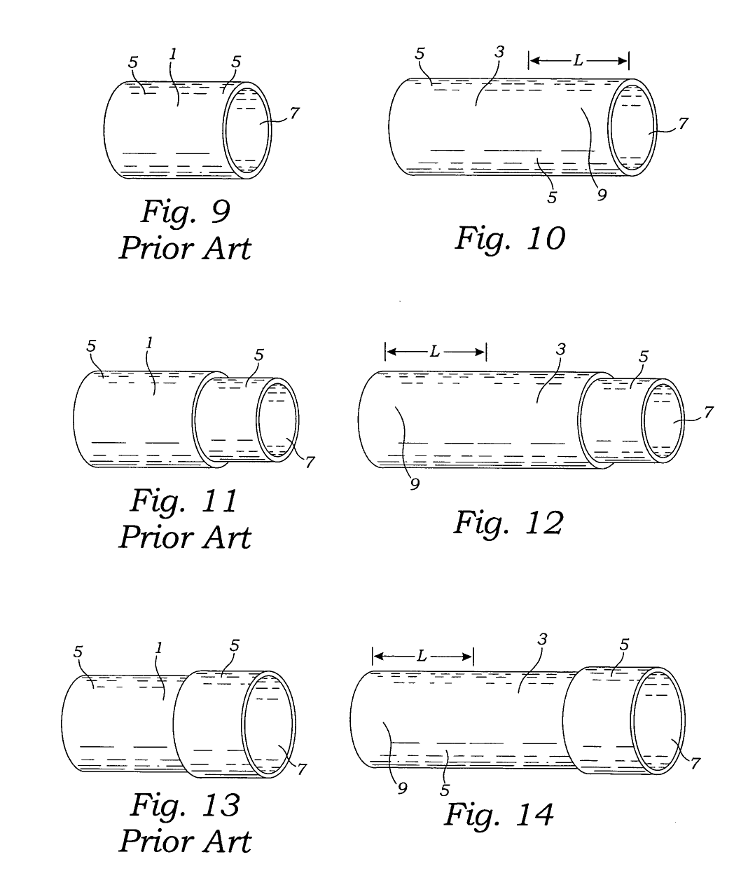

The invention has now been described in general terms as the invention can be utilized to replace an infinite number of different types of couplings. For examples only, FIG. 1 illustrates a traditional elbow coupling which can be replaced utilizing the elbow coupling shown in FIG. 2. FIG. 3 illustrates a traditional 45 degree elbow coupling which can be replaced by the elbow coupling illustrated in FIG. 4. FIG. 5 illustrates a traditional “Y” coupling which can be replaced utilizing a “Y” coupling shown in FIG. 6. FIG. 7 illustrates a traditional “T” coupling which can be replaced by the “T” coupling shown in FIG. 8. FIG. 9 illustrates a male-to-male coupling which can be replaced with the male-to-male coupling illustrated in FIG. 10. FIG. 11 illustrates a traditional male-to-female coupling which can be replaced utilizing the male-to-female coupling shown in FIG. 12. Finally, FIG. 13 illustrates a traditional female-to-male coupling which can be replaced utilizing the female-to-male coupling shown in FIG. 14. Each of the couplings illustrated in FIGS. 1-14 are for demonstration purposes only as the invention can be utilized to replace couplings having even different configurations from those illustrated.

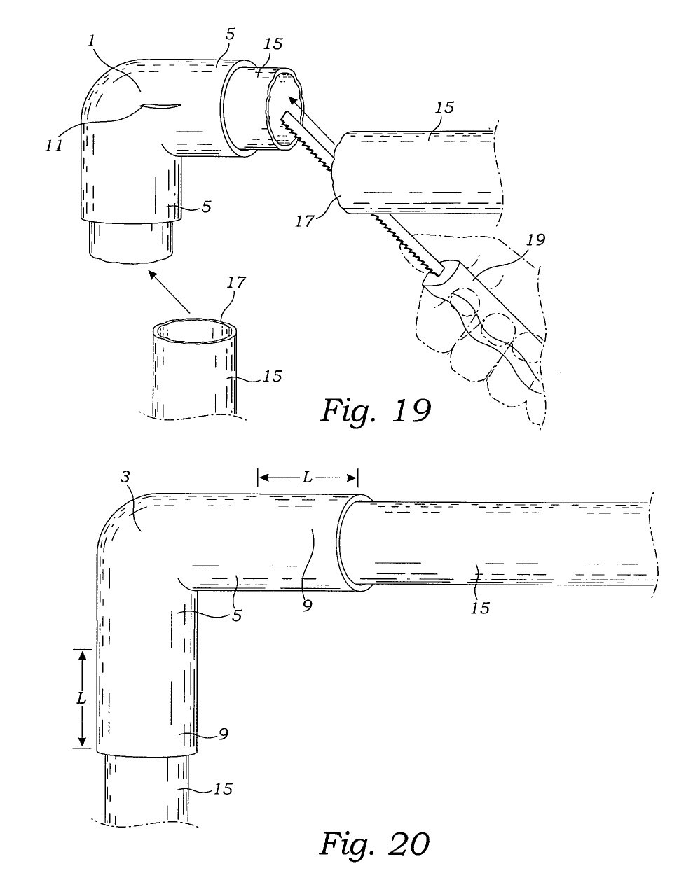

In describing the invention in more specific terms, FIGS. 19 and 20 illustrate the replacement of a traditional 90 degree elbow coupling 1 suffering from a crack 11. The pipe ends 17 are cut adjacent to the couplings tubular sections 5 utilizing a handsaw 19. Once both pipes 15 have been cut, the initial coupling 1 is replaced with a replacement coupling 3 having extensions 9 of a length “L”. Preferably the length “L” is substantially equal to or greater than the pipe length that has been removed from the pipe 15. The shortened pipes 15 are inserted into the central bores 7 of the replacement couplings tubular sections 5. As a result of the extension's 9 extra length “L”, the respective pipes 15 do not need to be extended.

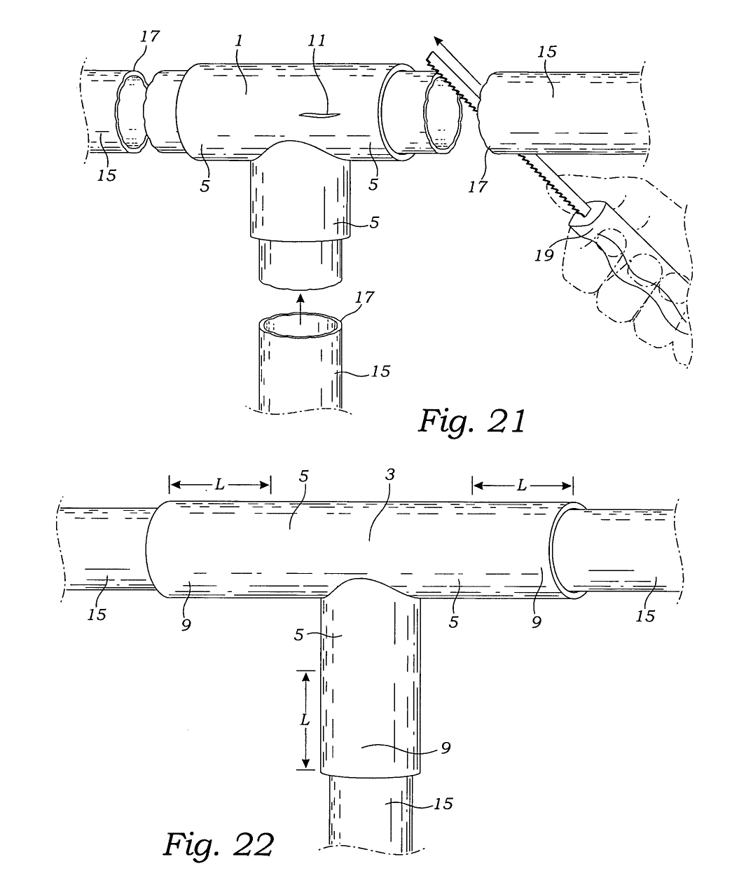

FIGS. 21 and 22 illustrate the replacement of a damaged “T” coupling 1. The three pipes 15 entering into the coupling 1 are severed using a handsaw 19 or the like. Since all three pipes are severed, the coupling 1 is removed to be replaced with the replacement coupling 3. Since all three pipes 15 have a shorter length, it is important that all three tubular sections 5 of the replacement “T” coupling 3 have extensions 9 of a length sufficient to receive the pipe ends 17. Again, it is preferred that the length “L” of the tubular sections 5 be the same or greater than the lengths of pipe that have been removed. Once each of the pipe ends 17 have been inserted into the tubular sections central bores 7, preferably in a press-fit arrangement, the pipe ends are affixed to the coupling utilizing an adhesive that has been previously applied to the interior of the replacement couplings tubular sections or applied to the exterior of the pipe ends 17. Alternatively, wherein the pipes 15 and coupling 3 are made of metal, such as brass, the respective components are preferably welded together utilizing traditional welding methods. As an alternative to the use of adhesives, or welding, a locking flange (not shown) may be employed.

The previous embodiments of the invention have illustrated the replacement of couplings wherein each of the tubular sections 5 had an extended length “L”. However, as would be understood by those skilled in the art, wherein two pipes are joined longitudinally to one another, such as utilizing a male-to-male coupling, male-to-female coupling, or female-to-female coupling, the replacement coupling would not require that both ends of the replacement coupling be extended. Accordingly, as illustrated in FIGS. 11-14, either end of a longitudinal coupling may be extended, which may be either a male-to-female fitting or a female-to-male fitting.

Numerous additional modifications of the method of replacing a pipe coupling can be made without departing from the spirit and scope of the invention. For example, several traditional pipe couplings have been illustrated including elbow joints, “T” joints, etc. However, still additional couplings not described having an infinite number of constructions can be replaced in accordance with the present invention. Moreover, the invention has been described having particular application to replacing the couplings of pipe joints made of PVC or brass. However, the invention is not intended to be limited to a pipe joint of a particular material.

Accordingly, having described my invention in such terms to enable those skilled in the art to make and use it, and having identified the presently preferred embodiments thereof, I claim:

1. A method of replacing a pipe coupling comprising the steps of:
providing a pipe joint including a first coupling having at least a first tubular input section having a length and a second tubular input section having a length, said pipe joint further including a first pipe telescopically joined to said first tubular input section and a second pipe telescopically joined to said second tubular section;
providing a second “replacement” coupling including a first tubular input section having a length greater than the length of said first coupling's first input section and a second tubular input section having a length greater than the length of said first coupling's second input section;
removing said first coupling from said pipe joint by cutting said first pipe adjacent to said first coupling and by cutting said second pipe adjacent to said first coupling wherein said first pipe is shorter than prior to said cutting and said second pipe is shorter than prior to said cutting; and
after removing said first coupling from said pipe joint, coupling said first and second pipes together with said replacement coupling by telescopically joining said replacement coupling's first tubular input section to said first pipe and telescopically joining said replacement coupling's second input section to said second pipe to form a pipe joint.

2. The method of replacing a pipe coupling of claim 1 wherein the first coupling and replacement coupling are selected from the group consisting of: a 90 degree elbow coupling, a 45 degree elbow coupling, a male to female coupling, a male to male coupling, a female to female coupling, a “T” coupling having three tubular input sections, and a “Y” coupling having three tubular input sections.

3. The method of replacing a pipe coupling of claim 1 wherein the first coupling and replacement coupling are elbow couplings.

4. The method of replacing a pipe coupling of claim 1 wherein the first coupling, replacement coupling, first pipe and second pipe are made substantially of brass.

5. The method of replacing a pipe coupling of claim 1 wherein the first coupling, replacement coupling, first pipe and second pipe are made substantially of polyvinyl chloride (PVC).

6. A method of replacing a pipe coupling comprising the steps of:
providing a pipe joint including a first coupling having at least a first tubular input section having a length and a second tubular input section having a length, said pipe joint further including a first pipe telescopically joined to said first tubular input section and a second pipe telescopically joined to said second tubular section;
providing a second “replacement” coupling including a first tubular input section and a second tubular input section, at least said replacement coupling's first input section having a length greater than the length of said first coupling's first input section;
removing said first coupling from said pipe joint by cutting said first pipe adjacent to said first coupling and by cutting said second pipe adjacent to said first coupling wherein said first pipe is shorter than prior to said cutting and said second pipe is shorter than prior to said cutting; and
after removing said first coupling from said pipe joint, coupling said first and second pipes together with said replacement coupling by telescopically joining said replacement coupling's first tubular input section to said first pipe and telescopically joining said replacement coupling's second input section to said second pipe to form a pipe joint.

7. The method of replacing a pipe coupling of claim 6 wherein the first coupling and replacement coupling are selected from the group consisting of: a male to female coupling, a male to male coupling, and a female to female coupling.

8. The method of replacing a pipe coupling of claim 6 wherein the replacement coupling's second input section has a length greater than the length of said first coupling's second input section.

9. The method of replacing a pipe coupling of claim 6 wherein the first coupling and replacement coupling are elbow couplings.

10. The method of replacing a pipe coupling of claim 6 wherein the first coupling, replacement coupling, first pipe and second pipe are made substantially of brass.

11. The method of replacing a pipe coupling of claim 7 wherein the first coupling, replacement coupling, first pipe and second pipe are made substantially of polyvinyl chloride (PVC).
